(19) United States
(12) Patent Application Publication
(10) Pub. No.: US 2026/0095338 A1
(43) Pub. Date: Apr. 2, 2026

(54) Physically Obfuscated Key Generation Circuit

(71) Applicant: Infineon Technologies AG, Neubiberg (DE)

(72) Inventor: Stefan Seidl, Unterhaching (DE)

(21) Appl. No.: 19/348,609

(22) Filed: Oct. 2, 2025

(30) Foreign Application Priority Data
Oct. 2, 2024 (DE) 102024209679.2

(51) Int. Cl. H04L 9/32; H03K 17/687

(52) U.S. Cl. CPC H04L 9/3278; H03K 17/6872

(57) ABSTRACT

According to various embodiments, a physically obfuscated key generation circuit is described, comprising an entropy source, a masking circuit, configured to receive a first entropy source output signal and a second entropy source output signal and output them depending on a masking control signal, a signal forwarding circuit and a latch circuit configured to, in a first mode, load a first node with a current provided by the signal forwarding circuit and load a second node with a current provided by the signal forwarding circuit and, in a second mode, to latch the state of the first node and the state of the second node and output a physically obfuscated key bit according to the latched states of the first node and the second node.

### TECHNICAL FIELD

The present disclosure relates to key generation circuits.

### BACKGROUND

Physically unclonable functions (PUFs) are used to generated physically obfuscated keys (POKs), e.g., for use in authentication, verification, and cryptographic operations. PUFs can be implemented by circuits, components, processes or other entities capable of generating an output, such as a digital bit, word or a function that provides resistance to cloning.

Typically, a PUF value (and thus one or more POK bits) can be generated based on inherent physical characteristics of a device such as individual physical characteristics of a transistor. One example is a threshold voltage of the transistor that varies due to local process variations during manufacturing. There is no need to store the PUF value or POK within the device, because the PUF can be generated repeatedly. It is nearly impossible to clone a device having a PUF implemented in a manner to generate the same PUF output with another device.

There exist circuits that can effectively generate POKs. However, it is desirable that an attacker cannot find out information about the POKs of devices by monitoring the circuits, since this could allow the attacker to clone the devices. Accordingly, improved POK generation circuits are desired.

### SUMMARY

According to various embodiments described in detail below, a physically obfuscated key generation circuit is provided, comprising:
an entropy source configured to output a first entropy source output signal and a second entropy source output signal;
a masking circuit, configured to receive the first entropy source output signal and the second entropy source output signal and output, depending on a masking control signal supplied to the masking circuit, either
   the first entropy source output signal as a first intermediate signal and the second entropy source output signal as a second intermediate signal or
   the second entropy source output signal as the first intermediate signal and the first entropy source output signal as the second intermediate signal;
a signal forwarding circuit having a first controlled current source and a second controlled current source, wherein the signal forwarding circuit is configured to control the first controlled current source by the first intermediate signal and to control the second controlled current source by the second intermediate signal and to provide the current provided by the first controlled current source at a first node and the current provided by the second controlled current source at a second node; and
a latch circuit configured to,
   in a first mode, load the first node with the current provided by the first controlled current source and load the second node with the current provided by the second controlled current source and
   in a second mode to latch the state of the first node and the state of the second node and output a physically obfuscated key bit according to the latched states of the first node and the second node.

### BRIEF DESCRIPTION OF THE FIGURES

In the drawings, similar reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows an electronic device.

FIG. 2 shows a POK (physically obfuscated key) generation circuit for the generation of one bit of a POK.

FIG. 3 shows an exemplary voltage-time-diagram and a trigger signal according to an embodiment.

FIG. 4 shows an example of a POK generation circuit in more detail.

FIG. 5 shows a POK generation circuit according to an embodiment which hardening against laser voltage probing or similar attacks.

FIG. 6 shows a POK generation circuit according to an embodiment.

### DETAILED DESCRIPTION

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

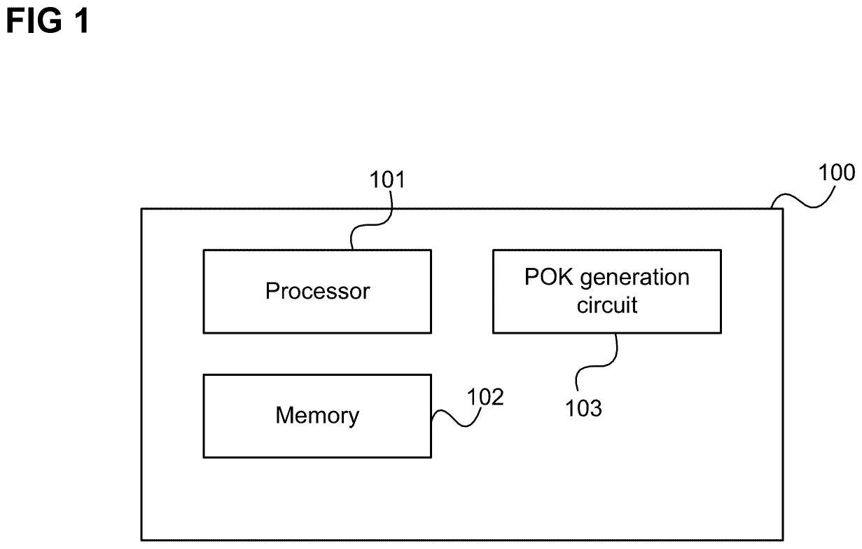

FIG. 1 shows an electronic device 100.

The electronic device is a data processing device like a microcontroller, smart card (of any form factor), secure microcontroller, hardware root of trust, (embedded) secure element (ESE), Trusted Platform Module (TPM), or Hardware Security Module (HSM). The electronic device may refer to a single chip, i.e. an integrated circuit, e.g. implementing a system on chip (SoC).

The electronic device 100 comprises a processor 101 (e.g. a CPU), a memory (e.g. a RAM) 102 and a POK generation circuit 103. The POK generation circuit 103 provides, e.g. upon start-up of the electronic device 100 or when challenged, a POK having multiple bits. For the POK generation, the POK generation circuit 103 uses one or more entropy sources which provide it with secret information which can be seen as fingerprint information of the electronic device 100. For example, the processor 101 only performs a certain function if the POK generation circuit 103 provides a correct POK. This protects against cloning of the electronic device.

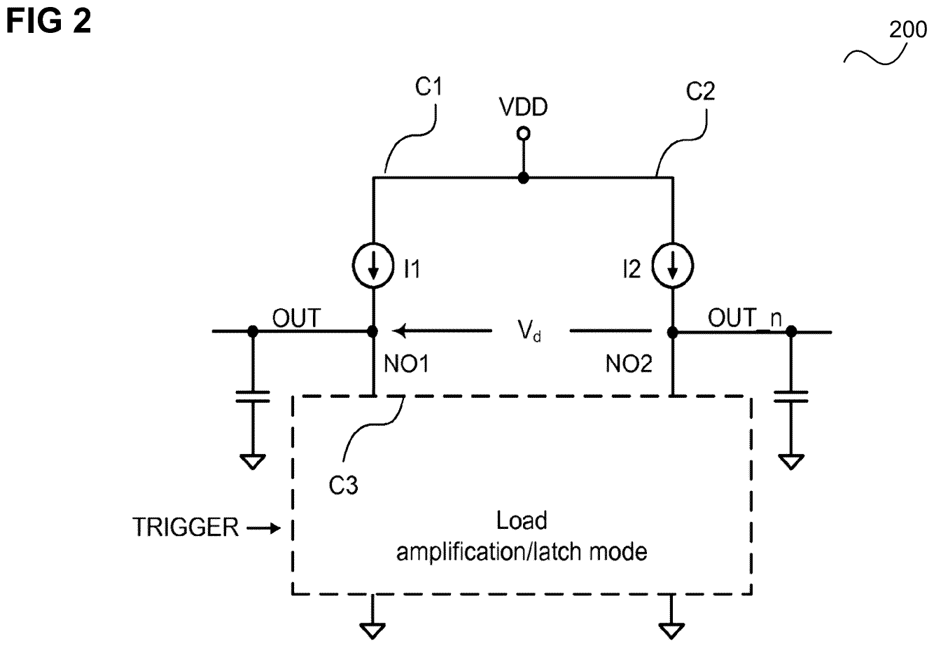

FIG. 2 shows a POK (bit) generation circuit 200 for the generation of one bit of a POK (also referred to as “POK bit” herein). The POK (bit) generation circuit 200 may be a sub-circuit of a larger POK generation circuit. For example, the POK generation circuit 103 includes multiple ones of the POK (bit) generation circuits 200 as sub-circuits such that it can generate a POK consisting of multiple (POK) bits, e.g. when requested to do so by the CPU 104. Nevertheless, although the circuit of figure provides only one POK bit, it is referred to as POK generation circuit 200 for simplicity (this also holds for the other examples below).

The POK generation circuit 200 comprises a first circuit C1 to generate a current signal I1 which is provided via a node NO1 to a third circuit C3. Based on the current signal I1, a voltage signal OUT is generated at the node NO1 that is based on random parametric variations of one or more elements in the first circuit C1. A second circuit C2 is provided in the POK generation circuit 200 to generate a second current I2 which is provided via a node NO2 to the third circuit C3. The second current I2 is based on random parametric variations of at least one element in the second circuit C2.

The third circuit C3 provides a load circuit and is capable to be operated in a first mode herein further referred to as an amplification mode and in a second mode herein further referred to as a latch mode. Depending on whether the third circuit C3 operates in an amplification mode or a latch mode, different stable states are obtained for the POK generation circuit causing for the voltage signals OUT and OUT_N at the nodes NO1 and NO2 different values in the steady states depending on the operation mode. A stable state of the circuit is obtained when the potentials and the currents at the different nodes are in a steady state, i.e. are substantially maintained at least for some time.

The trigger signal TRIGGER causes the circuit C3 to work either as an amplifier or as a latch. When the trigger signal TRIGGER is low, the third circuit C3 operates as an amplifier and generates a differential voltage Vd that is proportional to the offset I1−I2=ΔI. During the amplification mode, the output signals OUT, OUT_n are therefore analog signals. When the trigger signal TRIGGER is raised, the third circuit C3 switches to latch mode which provides the digitization or latching of the PUF signal by pulling the higher one of the two signals OUT and OUT_n to a high supply potential and the lower one of the two signals OUT and OUT_n to a low supply potential. In an embodiment, the high supply potential may be VDD and the low supply potential may be ground herein referenced as GND. The signals OUT, OUT_n are then maintained or latched at VDD or GND for providing the POK bit.

In one embodiment, the POK generation circuit 200 comprises a first transistor in the first circuit C1 wherein an operating characteristic of the first transistor is represented by the first output signal OUT. Furthermore, a second transistor is provided in the second circuit C2, wherein an operating characteristic of the second transistor is represented by the second output signal OUT_n. The transistors may for example include metal oxide semiconductor field effect transistors (MOSFETs) or other field effect transistors. The measurable output of each MOSFET pair may be in one embodiment the difference between their drain currents, which is highly susceptible to fluctuations that naturally occur in the fabrication process. The transistor pairs, i.e. the circuits C1 and C2, may therefore be seen to form an entropy source. In one embodiment, the POK generation circuit 200 comprises a first array of transistors in the first circuit C1, wherein the first output signal OUT is an operating characteristic of the first array of transistors and a second array of transistors in the second circuit C2, wherein the second output signal OUT_n is an operating characteristic of the second array of transistors.

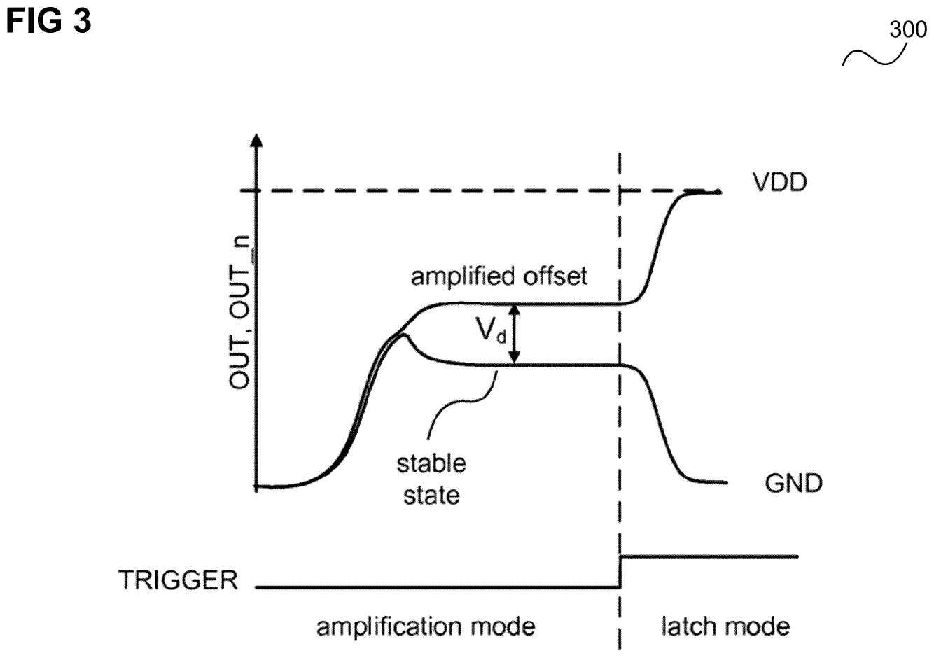

FIG. 3 shows an exemplary voltage-time-diagram 300 and a trigger signal according to an embodiment. At the beginning of the generation of a POK bit, the nodes NO1 and NO2 are forced into a predetermined state such that the voltages at both nodes NO1 and NO2 are identical for example at zero voltage. The predetermined state in which both are forced to the same potential is an unstable state for the POK generation circuit 200.

The POK generation circuit 200 is configured to generate a first potential at the first output node NO1 based on the first current I1 and to generate a second potential at the second node NO2 based on the second current I2. The POK generation circuit 200 is configured to gradually evolve the first potential and the second potential from the unstable state into a corresponding stable state which is maintained until the end of the amplification mode. The POK generation circuit 200 generates based on the stable states a first latch potential at the first output node NO1 and a second latch potential at the second output node NO2 in the latch mode.

According to various embodiments, the difference Vd between the stable state of the first potential and the second potential is smaller than the difference value between the first latch potential and the second latch potential. The difference value Vd between the stable state of the first potential and the stable state of the second potential depends on the random parametric variations in the first circuit C1 and the second circuit C2. The first circuit C1 and the second circuit C2 therefore form an entropy source or PUF.

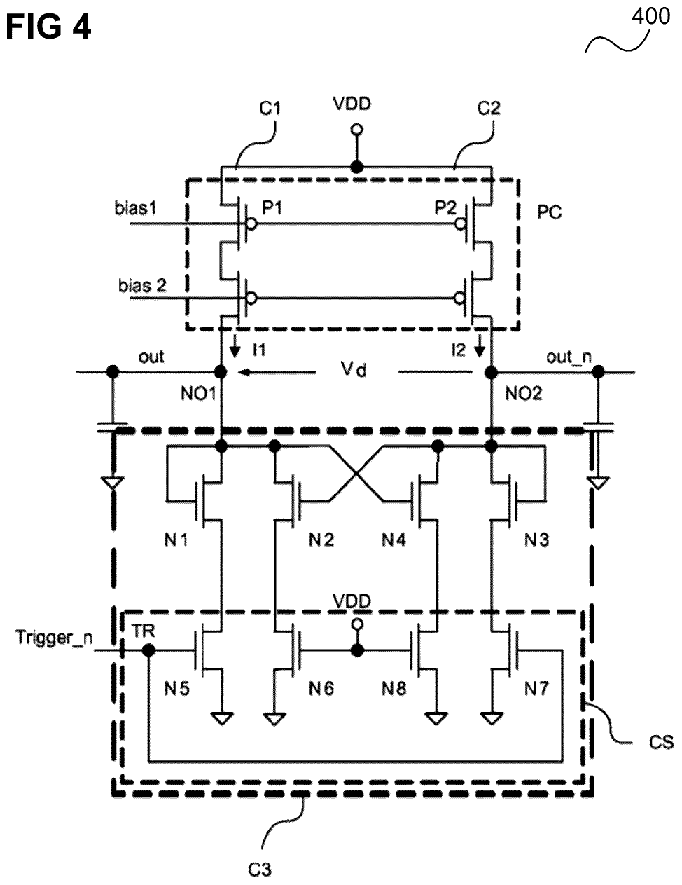

FIG. 4 shows an example of a POK generation circuit 400 in more detail.

In this embodiment, the third circuit C3 comprises a first NMOS (n-channel metal oxide semiconductor) transistor N1, a second NMOS transistor N2, a third NMOS transistor N3 and a fourth NMOS transistor N4 and the switching circuit CS comprises a fifth NMOS transistor N5, a sixth NMOS transistor N6, a seventh NMOS transistor N7 and an eighth NMOS transistor N8.

The drain and the gate of the NMOS transistor N1, the drain of the NMOS transistor N2 and the gate of the NMOS transistor N4 are connected to the first output node NO1 of the first circuit C1. The drain and the gate of the NMOS transistor N3, the drain of the NMOS transistor N4 and the gate of the NMOS transistor N2 are connected to the second output node NO2 of the second circuit C2.

The drain of the NMOS transistor N5 is connected to the source of the NMOS transistor N1, the drain of the NMOS transistor N6 is connected to the source of the NMOS transistor N2, the drain of the NMOS transistor N8 is connected to the source of the NMOS transistor N4, the drain of the NMOS transistor N7 is connected to the source of the NMOS transistor N3. The gates of the NMOS transistor N5 and the NMOS transistor N7 are connected to a trigger node TR to receive a trigger signal TRIGGER_n and the gates of the NMOS transistor N6 and the NMOS transistor N8 are connected to VDD.

The sixth NMOS transistor N6 and the eighth NMOS transistor N8 are optional and can be replaced by direct connections between the connected to the source of the NMOS transistor N2 to ground and the connected to the source of the NMOS transistor N4 to ground, respectively.

Two nominally bias signals bias1, bias2 are provided to a PMOS (p-channel metal oxide semiconductor) cascode current mirror, denoted by PC in FIG. 4. Process variations of the current generating transistors cause a current mismatch I1−I2=ΔI. In an embodiment, minimum area well-matched transistors are used in order to avoid systematic offset.

The third circuit C3 is implemented by means of the four matched NMOS transistors N1, N2, N3, N4. NMOS transistor N1 and the NMOS transistor N3 are diode-connected thus behaving as positive impedance, while the second NMOS transistor N2 and the fourth NMOS transistor N4 are cross-coupled and, regarding differential mode, can be seen as negative impedances.

The NMOS transistors N5, N6, N7 and N8 are used in this embodiment to implement the switching between amplification and latch mode. The actual switching is implemented by the fifth NMOS transistor N5 and the seventh NMOS transistor N7, where the fifth NMOS transistor N5 and the seventh NMOS transistor N7 are triggered over a trigger node TR with an inverted trigger signal TRIGGER_n. The NMOS transistors N6 and N8 are provided to preserve the matching between the NMOS transistor N1 to the NMOS transistor N2 and the NMOS transistor N3 to the NMOS transistor N4 but have otherwise no other function. The gates of transistors N6 and N8 are connected to VDD which causes them to be always active.

During amplification mode the inverted trigger signal TRIGGER_n is “1” setting NMOS transistors N5 and N7 to be active.

At the beginning of the amplification mode, the nodes NO1 and NO2 are forced to the same potential, for example 0 V, and thereafter released. After releasing, the node NO1 is charged by current I1 and the node NO2 is charged by current I2 causing an increase of the potentials at nodes NO1 and NO2. Already a slight difference in the currents I1 and I2 will cause a difference in the potentials at nodes NO1 and NO2. Assuming, for example, current I1 to be slightly higher than current I2, node NO1 will sooner be at the NMOS transistor threshold potential. In other words, NMOS transistors N1 and N4 become active before NMOS transistors N2 and N3 become active.

Once NMOS transistors N1, N2, N3 and N4 have become active, the positive admittances due to the NMOS transistor N1 and the NMOS transistor N3 cancel the negative differential admittances due to the NMOS transistor N2 and the NMOS transistor N4 respectively. It can be shown that when currents I1 and I2 have different values, an asymmetric stable state is obtained in which the potentials at NO1 and NO2 are different when realistic properties of NMOS transistors are assumed. Transistors N1 and N3 act in view of the gate connection as a diode. Therefore, distinguished from the latch mode, the nodes NO1 and NO2 are biased via the transistors N1 and N3 acting as diodes. This configuration causes the circuit to reach a stable state wherein the potentials at NO1 and NO2 are different but are neither pulled to VDD nor to GND (ground, i.e. low supply potential) as in a latch. The amplification can then be determined by the difference in the conductance values of the diode transistors and the positive feedback transistors.

In the amplification mode, noise can be filtered and the dynamic effects that could occur during its activation are rejected. Capacitances can be connected to the nodes NO1 and NO2 as shown in FIG. 4 for further filtering and reducing the impact of noise thereby increasing the circuit robustness. The capacitances can be added without having a negative effect on the amplified offset and the decision security is not affected even when the capacitances are not matched since the latch mode is only triggered when the steady state in the amplification mode has been reached in which the potentials at the nodes NO1 and NO2 are sufficiently separated.

In other words, while in the latching of a pure latch starting from equal potentials at nodes NO1 and NO2 the decision can be reversed by slight change of the potentials or currents due to noise, the amplification mode allows such effects to be canceled at least better than in the latch mode. The extent to which the amplification mode is capable to tolerate noise depends on the ration of the noise intensity to mismatch. Basically, in a pure latch mode the circuit will decide its state depending on whether node NO1 or NO2 rises faster. This can also depend on several parasitic effects not only on the static current mismatch between I1 and I2.

The latch mode starts when the inverted trigger signal TRIGGER_n falls to “0” causing the NMOS transistors N5 and N7 to shut down. With the NMOS transistors N5 and N7 shut down, no current is drawn by NMOS transistors N1 and N3. Therefore, the cross-coupled NMOS transistor N2 and NMOS transistor N4 make the load operate straightforward as a latch. As described above, in the latch mode the decision in which direction the latch latches is depending on which of the nodes NO1 and NO2 charges faster to the threshold potential at which N2 and N4 become active. Since the potential at the nodes NO1 and NO2 are already sufficiently separated due to previous amplifying mode at the starting of the latch mode, the latching is less prone to noise and the reversal of a latching due to noise is less likely to occur.

As illustrated in FIG. 3, during the amplification mode, the potential difference Vd, between out and out_n, is low, in an embodiment on average less than 50 mV. Such a small delta cannot be resolved by optical attacks. However, when changing into the latch mode, Vd increases close to the core voltage of the electronic device, which is typically of the order of 1V. Therefore, despite the small size of the connected transistors, an optical detection of the relative voltages is expected to be feasible. Hence, secrets (i.e. information about the POK bits) might be leaked.

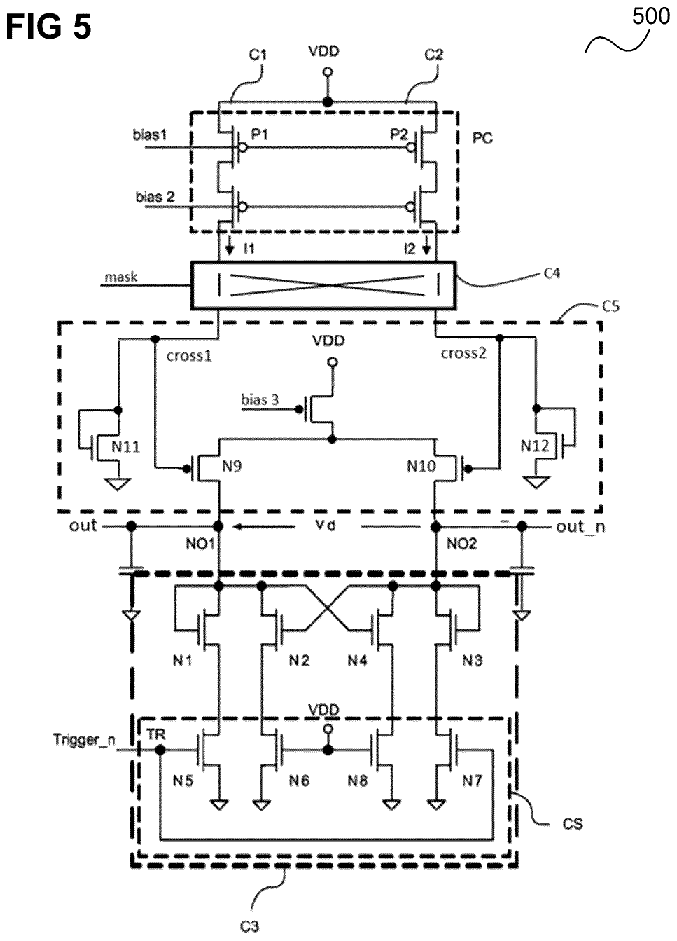

FIG. 5 shows a POK generation circuit 500 according to an embodiment which hardening against laser voltage probing or similar attacks.

In comparison to the POK generation circuit 400 of FIG. 4, two additional components C4 and C5 are added. They separate C1 and C2, i.e. the origin of the device-individual bit (e.g. chip-individual) POK bit (i.e. the entropy source), from the amplification and latching circuit C3. In other words, C4 and especially C5 decouple C3 from C1 and C2.

C4 is a controlled crossing element. It has a control input called mask. Depending on the value of mask the currents I1 and I2 will either go straight through to the nodes cross1 and cross2 or will be crossed so that I1 goes to cross2 and I2 to cross1.

The crossing in C4 can be realized by transmission gates, consisting of an NMOS and a PMOS transistor (or using just a single MOS type, i.e. NMOS or PMOS). The crossing element C4 is configured such the currents I1 and I2 are affected only in a neglectable amount by those transistors.

The circuit C5 mimics the circuit C3 in the amplification mode. The transistors N11 and N12 take the roles of the transistors N1 and N3. So, the nodes cross1 and cross2 show similar voltages as out and out_n (see FIG. 2) in amplification mode. Accordingly, the voltage difference between cross1 and cross2 is too small to be measured optically.

Nevertheless, the potential difference between cross1 and cross2 leads to different currents through the transistors N9 and N10. These currents can be interpreted as replicas of I1 and I2. Depending on the value of the mask input to C4, the current through N9 will either be the replica of I1 or of I2 and the current through N10 either I2 or I1.

As the voltage separation in the latch mode will only act on the transistors N9, N10 and transistors in C3, an optical readout of it is only possible after the currents were crossed or not. Even if the attacker would be able to read the separated voltages with one shot, without knowing the masking bit, no information is leaked. Furthermore, today all optical attacks are far from reading this information in one shot. Dozens of repetitive separation events need to be overlayed to obtain the required information. A randomly changing mask input will make those attacks impossible.

A good matching between the transistors N11 and N12, N1 and N3, N9 and N10 is required to reliable produce the inverted output when changing the mask bit. Monte Carlo simulations show that this is achievable for reasonable transistor sizes.

An extension of the POK generation circuit by a crossing circuit (or masking circuit), C4 in the above example) and a forwarding circuit (or decoupling circuit), C5 in the above example, allows generating a device-individual (e.g. chip-individual) bit sequence (fingerprint) while avoiding the weakness against optical attacks.

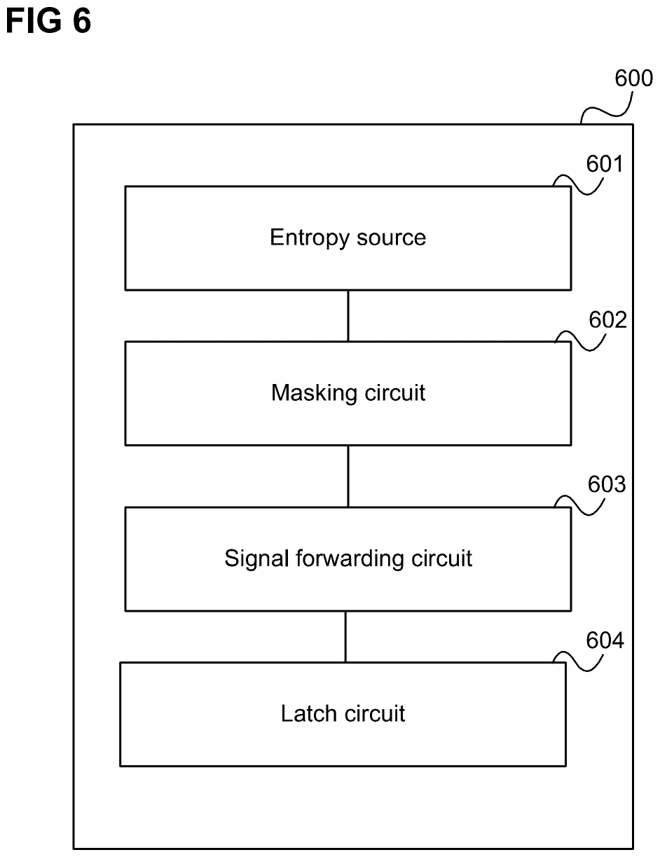

In summary, according to various embodiment, a circuit is provided as illustrated in FIG. 6.

FIG. 6 shows a physically obfuscated key (POK) generation circuit 600 according to an embodiment.

The POK generation circuit 600 comprises an entropy source 601 (or, in other words, a PUF) configured to output a first entropy source output signal and a second entropy source output signal.

The POK generation circuit 600 further comprises a masking circuit 602 (C4 in the example of FIG. 5), configured to receive the first entropy source output signal and the second entropy source output signal and output, depending on a (e.g. digital) masking control signal (e.g. a mask bit) supplied to the masking circuit, either
the first entropy source output signal as a first intermediate signal (at a first output of the masking circuit) and the second entropy source output signal as a second intermediate signal (at a second output of the masking circuit; e.g. in response to the masking control signal having a first value) or
the second entropy source output signal as the first intermediate signal (at the first output of the masking circuit) and the first entropy source output signal as the second intermediate signal (at a second output of the masking circuit). In other words, depending on the masking control signal, the masking circuit exchanges (or swaps) the first entropy source output signal and the second entropy source output signal or not, i.e. the masking circuit distributes the entropy source output signals to its outputs depending on the masking control signal; e.g. in response to the masking control signal having a second value).

The POK generation circuit 600 further comprises a signal forwarding circuit 603 (C5 in the example of FIG. 5, it may also be seen as a decoupling circuit since it decouples the entropy source from the latch circuit) having a first controlled current source and a second controlled current source, wherein the signal forwarding circuit is configured to (receive the first intermediate signal and) control the first controlled current source by the first intermediate signal and to (receive the second intermediate signal and) control the second controlled current source by the second intermediate signal and to provide the current provided by the first controlled current source at a first node (NO1 in the example of FIG. 5) and the current provided by the second controlled current source at a second node (NO2 in the example of FIG. 5).

The POK generation circuit 600 further comprises a latch circuit 604 configured to
in a first mode (stabilization mode or also “amplification” mode), load the first node with the current provided by the first controlled current source and load the second node with the current provided by the second controlled current source and
in a second mode (latch mode) to latch the state of the first node and the state of the second node and output a physically obfuscated key bit according to the latched states of the first node and the second node.

According to various embodiments, in other words, the secret generating part is decoupled from the latch circuit, which separates the voltages (which reflect the generated secret, i.e. the voltages out and out_n in the above example) in the latch mode.

Various Examples are described in the following:

Example 1 is a physically obfuscated key generation circuit as described with reference to FIG. 6.

Example 2 is the physically obfuscated key generation circuit of example 1, wherein the latch circuit is configured to latch the state of the first node and the state of the second node to digital inverse digital states (i.e. one is inverse to the other, i.e. one is at a high reference potential and the other is at a low reference potential, or, on other words, one is a digital ‘1’ and the other is a digital ‘0’).

Example 3 is the physically obfuscated key generation circuit of example 1 or 2, wherein the first controlled current source and the second controlled current source are voltage-controlled current sources.

Example 4 is the physically obfuscated key generation circuit of any one of examples 1 to 3, wherein the first entropy source output signal and the second entropy source output signal are analog signals (and, accordingly, the first intermediate signal and the second intermediate signal are analog signals, too) and the signal forwarding circuit is configured to convert the first intermediate signal into a first voltage and to control the first controlled current source by the first voltage and to convert the second intermediate signal into a second voltage and to control the second controlled current source by the second voltage.

Example 5 is the physically obfuscated key generation circuit of example 4, wherein the first controlled current source comprises one or more first transistors, at least one of which is supplied with a high supply potential and at least one of which is controlled, at its gate, by the first voltage, and wherein the second controlled current source comprises one or more second transistors, at least one of which is supplied with the high supply potential and at least one of which is controlled, at its gate, by the second voltage at its gate.

Example 6 is the physically obfuscated key generation circuit of any one of examples 1 to 5, wherein the latch circuit is configured to receive a digital trigger signal and wherein the latch circuit is configured to transition from the first mode to the second mode in response to a level change of the digital trigger signal.

Example 7 is the physically obfuscated key generation circuit of any one of examples 1 to 6, wherein the entropy source comprises a third current source configured to provide the first entropy source output signal and a fourth current source configured to provide the fourth entropy source output signal.

Example 8 is the physically obfuscated key generation circuit of any example 7, wherein the third current source comprises one or more third transistors and the fourth current source comprises, for each third transistor, a respective fourth transistor whose gate is coupled to the gate of the third transistor.

Example 9 is the physically obfuscated key generation circuit of example 8, wherein the one or more third transistors are serially connected and supplied with a high supply potential and the one or more fourth transistors are serially connected and supplied with the high supply potential.

Example 10 is the physically obfuscated key generation circuit of any one of examples 1 to 9, wherein the masking circuit comprises one or more transmission gates connecting inputs of the masking circuit where the masking circuit receives the first entropy source output signal and the second entropy source output signal with outputs of the masking circuit where the masking circuit provides the first intermediate signal and the second intermediate signal, wherein the one or more transmission gates are controlled by the masking control signal.

Example 11 is the physically obfuscated key generation circuit of any one of examples 1 to 10, having multiple sub-circuits, wherein each sub-circuit is associated with a respective bit position of a physically obfuscated key, each sub-circuit comprising:
an entropy source configured to output a first entropy source output signal and a second entropy source output signal
a masking circuit, configured to receive the first entropy source output signal and the second entropy source output signal and output, depending on a masking control signal supplied to the masking circuit, either
   the first entropy source output signal as a first intermediate signal and the second entropy source output signal as a second intermediate signal or
   the second entropy source output signal as the first intermediate signal and the first entropy source output signal as the second intermediate signal
a signal forwarding circuit having a first controlled current source and a second controlled current source, wherein the signal forwarding circuit is configured to control the first controlled current source by the first intermediate signal and to control the second controlled current source by the second intermediate signal and to provide the current provided by the first controlled current source at a first node and the current provided by the second controlled current source at a second node; and
a latch circuit configured to, in the first mode, load the first node with the current provided by the first controlled current source and load the second node with the current provided by the second controlled current source and in the second mode to latch the state of the first node and the state of the second node and output a physically obfuscated key bit for the bit position associated with the sub-circuit according to the latched states of the first node and the second node.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A physically obfuscated key generation circuit, comprising:
an entropy source configured to output a first entropy source output signal and a second entropy source output signal;
a masking circuit, configured to receive the first entropy source output signal and the second entropy source output signal and selectively output, depending on a masking control signal supplied to the masking circuit, either
the first entropy source output signal as a first intermediate signal and the second entropy source output signal as a second intermediate signal or
the second entropy source output signal as the first intermediate signal and the first entropy source output signal as the second intermediate signal;
a signal forwarding circuit having a first controlled current source and a second controlled current source, wherein the signal forwarding circuit is configured to control the first controlled current source by the first intermediate signal and to control the second controlled current source by the second intermediate signal and to provide the current provided by the first controlled current source at a first node and the current provided by the second controlled current source at a second node; and
a latch circuit configured to, in a first mode, load the first node with the current provided by the first controlled current source and load the second node with the current provided by the second controlled current source and in a second mode to latch the state of the first node and the state of the second node and output a physically obfuscated key bit according to the latched states of the first node and the second node.

2. The physically obfuscated key generation circuit of claim 1, wherein the latch circuit is configured to latch the state of the first node and the state of the second node to digital inverse digital states.

3. The physically obfuscated key generation circuit of claim 1, wherein the first controlled current source and the second controlled current source are voltage-controlled current sources.

4. The physically obfuscated key generation circuit of claim 1, wherein the first entropy source output signal and the second entropy source output signal are analog signals and the signal forwarding circuit is configured to convert the first intermediate signal into a first voltage and to control the first controlled current source by the first voltage and to convert the second intermediate signal into a second voltage and to control the second controlled current source by the second voltage.

5. The physically obfuscated key generation circuit of claim 4, wherein the first controlled current source comprises one or more first transistors, at least one of which is supplied with a high supply potential and at least one of which is controlled, at its gate, by the first voltage, and wherein the second controlled current source comprises one or more second transistors, at least one of which is supplied with the high supply potential and at least one of which is controlled, at its gate, by the second voltage at its gate.

6. The physically obfuscated key generation circuit of claim 1, wherein the latch circuit is configured to receive a digital trigger signal and wherein the latch circuit is configured to transition from the first mode to the second mode in response to a level change of the digital trigger signal.

7. The physically obfuscated key generation circuit of claim 1, wherein the entropy source comprises a third current source configured to provide the first entropy source output signal and a fourth current source configured to provide the fourth entropy source output signal.

8. The physically obfuscated key generation circuit of claim 7, wherein the third current source comprises one or more third transistors and the fourth current source comprises, for each third transistor, a respective fourth transistor whose gate is coupled to the gate of the third transistor.

9. The physically obfuscated key generation circuit of claim 8, wherein the one or more third transistors are serially connected and supplied with a high supply potential and the one or more fourth transistors are serially connected and supplied with the high supply potential.

10. The physically obfuscated key generation circuit of claim 1, wherein the masking circuit comprises one or more transmission gates connecting inputs of the masking circuit where the masking circuit receives the first entropy source output signal and the second entropy source output signal with outputs of the masking circuit where the masking circuit provides the first intermediate signal and the second intermediate signal, wherein the one or more transmission gates are controlled by the masking control signal.

11. The physically obfuscated key generation circuit of claim 1, having multiple sub-circuits, wherein each sub-circuit is associated with a respective bit position of a physically obfuscated key, each sub-circuit comprising:
an entropy source configured to output a first entropy source output signal and a second entropy source output signal;
a masking circuit, configured to receive the first entropy source output signal and the second entropy source output signal and output, depending on a masking control signal supplied to the masking circuit, either the first entropy source output signal as a first intermediate signal and the second entropy source output signal as a second intermediate signal or the second entropy source output signal as the first intermediate signal and the first entropy source output signal as the second intermediate signal;
a signal forwarding circuit having a first controlled current source and a second controlled current source, wherein the signal forwarding circuit is configured to control the first controlled current source by the first intermediate signal and to control the second controlled current source by the second intermediate signal and to provide the current provided by the first controlled current source at a first node and the current provided by the second controlled current source at a second node; and
a latch circuit configured to, in the first mode, load the first node with the current provided by the first controlled current source and load the second node with the current provided by the second controlled current source and in the second mode to latch the state of the first node and the state of the second node and output a physically obfuscated key bit for the bit position associated with the sub-circuit according to the latched states of the first node and the second node.
